(19) United States
(12) Patent Application Publication
(10) Pub. No.: US 2026/0332076 A1
(43) Pub. Date: Oct. 22, 2026

(54) Operating method for a BLDC motor of an electric machine tool

(71) Applicant: Hilti Aktiengesellschaft, Schaan (LI)

(72) Inventors: Markus SCHERBAUM, Gennach (DE); Walter WISSMACH, Muenchen (DE); Justus FREISCHLE, Landsberg (DE); Anton KIDESS, Landsberg am Lech (DE)

(21) Appl. No.: 19/106,924

(22) PCT Filed: Aug. 21, 2023
(86) PCT No.: PCT/EP2023/072897

§ 371 Date: Feb. 26, 2025

(30) Foreign Application Priority Data
Sep. 7, 2022 (EP) 22194405.1

(51) Int. Cl. H02P 21/22

(52) U.S. Cl. CPC H02P 21/22

(57) ABSTRACT

A method for operating a drive unit of a machine tool, wherein the drive unit is supplied power by a system voltage, and the drive unit has a brushless DC motor and an inverter connected upstream of the DC motor, and wherein, as part of the method, a back-emf voltage which is induced in a respective stator winding of the brushless DC motor is determined, wherein the inverter is operated with field-oriented control, and its setpoint stator current value is subjected to amplitude modulation.

The present invention relates to a method for operating a drive unit of a machine tool, wherein the drive unit is supplied power by a system voltage, and the drive unit has a brushless DC motor (BLDC motor) and an inverter connected upstream of the DC motor. As part of the method, a back-emf voltage which is induced in a respective stator winding of the brushless DC motor is determined.

### BACKGROUND

Methods of this kind are known in principle from the prior art.

### SUMMARY OF THE INVENTION

It is an object of the present invention to provide a method for operating a drive unit of a machine tool which provides the basis for reduced switching losses and for an improved EMC behavior.

The present invention provides that the inverter is operated with field-oriented control, and its setpoint stator current value is subjected to amplitude modulation. This can be generated in dependence on the curve characteristic of the system voltage, the back-emf voltage and the manipulated variable of a speed controller.

It has been found to be advantageous if the brushless DC motor is subjected to field-oriented control as part of the method. In a particularly preferred configuration, the drive unit has a lean DC link connected upstream of the DC motor. A lean DC link is understood in particular to mean a DC link having a comparatively low storage capacity. This can be realized by compact film capacitors and/or small electrolyte capacitors having a low capacitance. In addition, the motor current amplitude can be modeled in such a way that an approximately sinusoidal system current characteristic having a high power factor results.

The invention includes the finding that, by virtue of operation of a BLDC motor with block commutation, as is the case in the prior art, in an inverter takeup current typically current harmonics having six times the electrical stator frequency and integral multiples thereof are generated. These inverter harmonics interact with the system impedance and in the process excite the RLC resonant circuit consisting of internal system resistance, system inductance and DC-link capacitance of lean DC electronics (lean DC link). If the six times the electrical motor rotation frequency coincides with the resonant frequency of the RLC resonant circuit, the harmonic amplitudes of the inverter takeup current are significantly increased in size and become visible in the system takeup current of the lean DC electronics. Owing to these oscillations, the power factor becomes very poor and can decrease to the region of approximately λ=0.7.

Owing to the method according to the invention, the basis for reduced switching losses and control with low current harmonics for markedly higher power factors is provided. This applies in particular for the case where the brushless DC motor is subjected to field-oriented control.

In a particularly preferred configuration, provision is made for the inverter to be driven in the drive mode on the basis of a setpoint value which takes into consideration both the system voltage and the back-emf voltage. It has been found to be advantageous if, as part of the setpoint value determination, the back-emf voltage is subtracted from an absolute value of the system voltage, and thus a first differential voltage is obtained. In a particularly preferred configuration, the first differential voltage is limited to the value zero for its negative voltage values.

In a further preferred configuration, provision is made for, as part of the setpoint value determination, the back-emf voltage to be subtracted from a system peak voltage of the system voltage, and thus a second differential voltage to be obtained. It has been found to be advantageous if the first differential voltage is divided by the second differential voltage, and the quotient thus obtained is preferably scaled to an amplitude value of one. In a further preferred configuration, the quotient, in particular the scaled quotient, is multiplied by a manipulated speed variable which originates from a speed controller of the drive unit and thus generates a setpoint stator current value.

In other words, the invention and configurations thereof are based on the concept of operating the BLDC motor by means of field-oriented control in order to significantly reduce fluctuations in the instantaneous power of the motor as well as, in consequence, fluctuations or current harmonics in the inverter takeup current. Furthermore, the setpoint value of the motor current control can be generated in such a way that the motor current is actively brought to zero when the time interval at the system zero crossing is reached. The breadth of the time interval at the system zero crossing at which there is no motor current flowing (switch-off mode) is in this case advantageously defined by the induced voltage of the brushless motor with the point of intersection of the instantaneous value of the system voltage.

An advantageous factor of the above-described setpoint value generation is that even distorted, nonsinusoidal input voltages are mapped in the characteristic of the motor current or, as a result thereof, in the characteristic of the input current. It is thus possible for a good power factor to be achieved even in the case of distorted, nonsinusoidal input voltages. In a particularly preferred configuration, the method is free from a block commutation of the BLDC motor.

In accordance with a further advantageous embodiment, it may be possible for the inverter to be driven in a switch-off mode in a time interval in which the system voltage is less than or equal to the back-emf voltage and otherwise to be driven in a drive mode. A switch-off mode is in particular understood to mean a mode in which the inverter is switched off (i.e. in particular is floating/at a high resistance). This preferably applies to all commutation blocks of the inverter. It has been found to be advantageous if the inverter drive signals are set to zero in the switch-off mode. A drive mode is in particular understood to mean a mode in which the inverter is controlled by a current controller, in particular in field-oriented fashion.

The present invention also provides a drive unit for a machine tool, wherein the drive unit is supplied or can be supplied power by a system voltage, and the drive unit has a brushless DC motor and an inverter connected upstream of the DC motor, and wherein the drive unit is designed to determine a back-emf voltage which is induced in a respective stator winding of the brushless DC motor. The drive unit is designed to drive the DC motor in the braking mode on the basis of a motor current amplitude and a reference variable which is dependent on a DC-link voltage of the DC link.

The drive unit is preferably part of an electric machine tool, in particular a handheld machine tool. The drive unit and the machine tool can be developed in a corresponding manner by the features described with reference to the method.

Further advantages will become apparent from the following description of the figures. Particularly preferred exemplary embodiments of the present invention are illustrated in the figures. The figures, the description, and the claims contain numerous features in combination. A person skilled in the art will expediently also consider the features individually and combine them to form sensible further combinations.

### BRIEF DESCRIPTION OF THE DRAWINGS

Identical and similar components are denoted by the same reference signs in the figures, in which:

FIG. 1 shows a block diagram for field-oriented control of a BLDC motor;

FIG. 2 shows a block diagram for generating the setpoint stator current value;

FIG. 3 shows exemplary characteristics of various intermediate signals in the setpoint value generation in accordance with the block diagram in FIG. 2; and

FIG. 4 shows exemplary characteristics of system voltage, motor currents and system current over the course of the field-oriented control of the BLDC motor.

### DETAILED DESCRIPTION

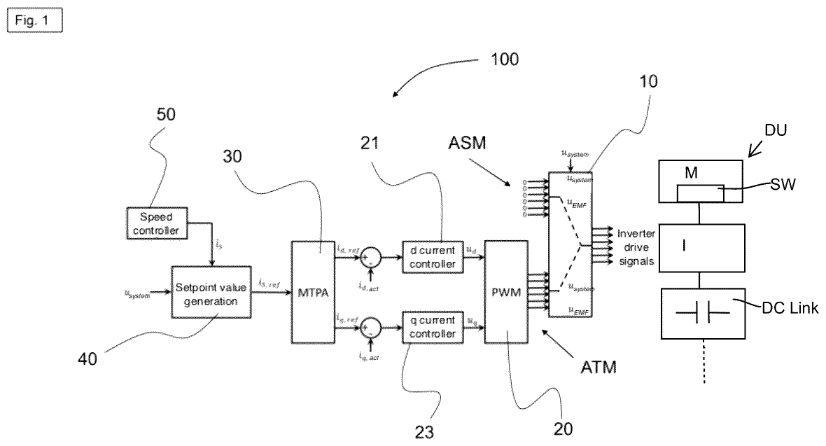

In the following, a preferred exemplary embodiment of the method is described on the basis of a field-oriented motor control with a rotor-fixed d/q coordinate system (Park transformation). For this purpose, FIG. 1 shows a block diagram 100 with which a drive unit DU, which has a brushless DC motor M (BLDC motor) with a stator winding SW, an inverter I and a DC link connected upstream of the inverter as shown solely schematically, can be driven.

The block diagram 100 has a switchover block 10, the six output signals of which are supplied to an inverter I (shown here schematically). The switchover block 10 can be operated in a switch-off mode ASM (“upper” path) and in a drive mode ATM (“lower path”). In the switch-off mode ASM, all of the inverter drive signals are set to zero. The switch-off mode ASM is in force in that time interval in which the system voltage u_{system} is less than or equal to the back-emf voltage u_{EMF}.

Otherwise, i.e. the system voltage u_{system} is greater than the back-emf voltage u_{EMF}, the drive mode ATM is in force, wherein the inverter I is subjected to field-oriented control by the current controllers 21, 23. For this purpose, the block diagram 100 furthermore has a PWM block 20 connected upstream of the switchover block 10 for pulse-width-modulated driving of the BLDC motor. In the drive mode ATM (“lower path”), the signals of the PWM block 20 are passed on to the inverter via the switchover block 10.

Input variables for the PWM block 20 are provided by said d current controller 21 and the q current controller 23. An MTPA (maximum torque per ampere) block 30 is connected upstream of the d current controller 21 and the q current controller 23 and outputs a setpoint d current and a setpoint q current. The MTPA block 30 in turn receives its setpoint current from a calculation block 40. The input variable for the calculation block 40 is a speed controller 50.

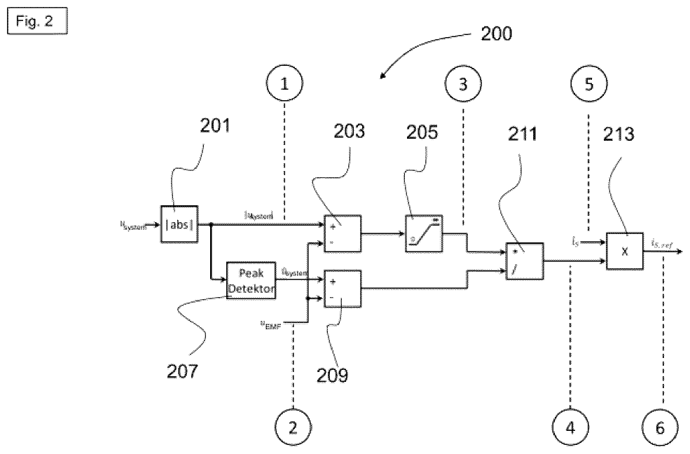

A block diagram 200 for generating the setpoint stator current value i_{S,ref} is illustrated in FIG. 2. The block diagram 200 represents, by way of example, the calculation block 40 in FIG. 1. The task of the calculation block 40 is to modulate the motor current in such a way that the inverter takeup current approximately follows the characteristic of the system voltage in order to obtain a good power factor; on the other hand, the motor current is also intended to be brought to the value zero when the system voltage u_{system} falls below the back-emf voltage u_{EMF}.

First, the system voltage u_{system} is converted by an absolute value block 201 into a rectified system voltage |u_{system}|. The back-emf voltage u_{EMF} is subtracted from this rectified system voltage |u_{system}| by means of a first subtraction block 203, and the negative values of said back-emf voltage are limited to zero by a limiter block 205. Likewise, the emf voltage u_{EMF} is subtracted from a system peak voltage û_{system} detected by means of a peak detection block 207. This takes place by means of a second subtraction block 209. The subsequent division by a division block 211 generates the characteristic of the waveform of a current reference signal which has been scaled to the amplitude one. The setpoint stator current value i_{S,ref}, which is at the same time the output variable of the calculation block 40 illustrated in FIG. 1, is ultimately reached by a multiplication of the output of the division block 211 by the desired amplitude î_{S}. This takes place by means of the multiplication block 213. The desired amplitude î_{S}, which is the manipulated variable of the speed controller 50 shown in FIG. 1, changes only slowly in relation to the system voltage u_{system}, so that, as a result, the characteristic in the form of the system voltage of i_{S,ref} is not distorted.

The setpoint value of the motor current control can advantageously be generated by the block diagram shown in FIG. 2 in such a way that the motor current is actively brought to zero when the time interval at the system zero crossing is reached.

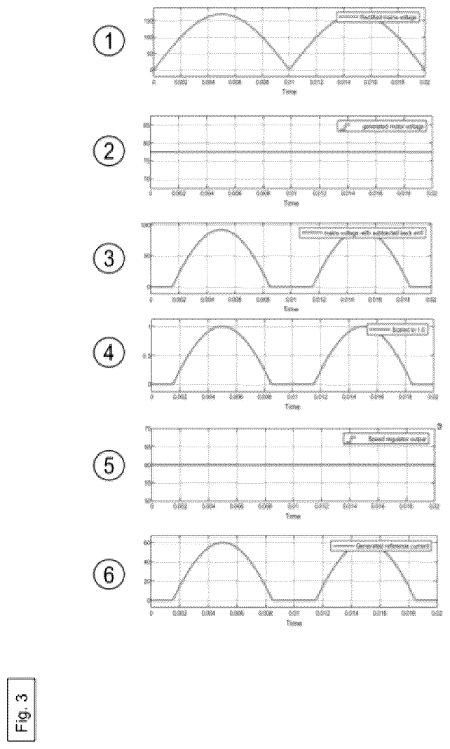

Exemplary time characteristics of various intermediate signals in the case of the setpoint value generation are illustrated in FIG. 3. In this case, the numbers given in each case on the left of the graphs correspond to the measurement points 1 to 6 illustrated in FIG. 2 (in each case circled).

Graph 1 shows the characteristic of the rectified system voltage |u_{system}| over time. Graph 2 shows the back-emf voltage u_{EMF}. Graph 3 shows the difference between the system voltage |u_{system}| and the back-emf voltage u_{EMF}, wherein this difference excludes negative values (cf. FIG. 2 limiter block 205). Graph 4 shows the quotient, scaled to the value one, of the first differential voltage and the second differential voltage. Graph 5 shows the manipulated variable î_{S}, which originates from the speed controller 50 shown in FIG. 1. Graph 6 finally shows the characteristic over time of the setpoint stator current value i_{S,ref} which is the output variable of the calculation block 40 illustrated in FIG. 1.

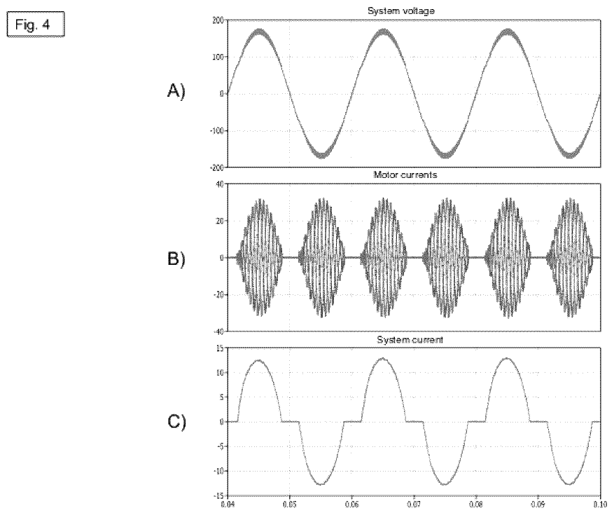

FIG. 4 shows typical characteristics of system voltage (graph A), the motor phase currents (graph B) and the system current characteristic (graph C) which result in the case of the exemplary configuration of the invention here. In the example in FIG. 5, advantageously a power factor of λ=0.97 is achieved.

### LIST OF REFERENCE SIGNS

10 switchover block
20 PWM block
21 d current controller
23 q current controller
30 MTPA block
40 calculation block
50 speed controller
100 block diagram for field-oriented motor control
200 block diagram for block-commutated motor control
201 absolute value block
203 first subtraction block
205 limiter block
207 peak detection block
209 second subtraction block
211 division block
213 multiplication block
î_{S} manipulated variable of speed controller
i_{S,ref} i_{S,ref} setpoint stator current value
u_{EMF} back-emf voltage
u_{system} system voltage
û_{system} system peak voltage
I inverter
M motor
SW stator winding
DU drive unit

1-13. (canceled)

14. A method for operating a drive unit of a machine tool, the method comprising:
supplying power to the drive unit via a system voltage, the drive unit having a brushless DC motor with a stator winding and having an inverter connected upstream of the DC motor;
determining a back-emf voltage induced in the stator winding; and
operating the inverter with field-oriented control, a setpoint stator current value being subjected to amplitude modulation.

15. The method as recited in claim 14 wherein the inverter is driven in a drive mode on the basis of a setpoint value taking into consideration both the system voltage and the back-emf voltage.

16. The method as recited in claim 15 wherein, as part of a determination of the setpoint value, the back-emf voltage is subtracted from an absolute value of the system voltage to obtain a first differential voltage.

17. The method as recited in claim 16 wherein the first differential voltage is limited to zero for negative voltage values.

18. The method as recited in claim 16 wherein, as part of the determination of the setpoint value, the back-emf voltage is subtracted from a system peak voltage of the system voltage to obtain a second differential voltage.

19. The method as recited in claim 18 wherein, as part of the determination of the setpoint value, the first differential voltage is divided by the second differential voltage.

20. The method as recited in claim 19 wherein, as part of the determination of the setpoint value, the quotient is multiplied by a manipulated speed variable originating from a speed controller of the drive unit, and thus the setpoint stator current value is generated.

21. The method as recited in claim 20 wherein the brushless DC motor is controlled in field-oriented fashion on the basis of the setpoint stator current value.

22. The method as recited in claim 21 further comprising passing the setpoint stator current value through an MTPA block.

23. The method as recited in claim 14 wherein the drive unit has a lean DC link connected upstream of the DC motor.

24. The method as recited in claim 14 wherein the inverter is driven in a switch-off mode in a time interval, the system voltage being less than or equal to the back-emf voltage in the time interval, and otherwise is driven in a drive mode.

25. A drive unit for a machine tool, the drive unit suppliable with power by a system voltage, the drive unit comprising:
a brushless DC motor; and
an inverter connected upstream of the DC motor, the drive unit designed to determine a back-emf voltage induced in a respective stator winding of the brushless DC motor,
the drive unit designed to drive the DC motor in the braking mode on the basis of a motor current amplitude and a reference variable dependent on a DC-link voltage of a DC link.

26. A machine tool comprising the drive unit as recited in claim 25.

27. A handheld machine tool comprising the drive unit as recited in claim 25.
